(19) United States
(12) Patent Application Publication
(10) Pub. No.: US 2018/0234245 A1
(43) Pub. Date: Aug. 16, 2018

(54) METHOD AND SYSTEM FOR NFC-BASED MOBILE TERMINAL PASSWORD STORAGE AND RECOVERY

(71) Applicant: HUIZHOU TCL MOBILE COMMUNICATION CO., LTD., Huizhou City, Guangdong Province (CN)

(72) Inventors: ZHANGFENG ZOU, Huizhou City, Guangdong Province (CN); BINJIAN TU, Huizhou City, Guangdong Province (CN); LINZHEN YANG, Huizhou City, Guangdong Province (CN); YONGJUN ZOU, Huizhou City, Guangdong Province (CN)

(21) Appl. No.: 15/571,028

(22) PCT Filed: Dec. 14, 2016
(86) PCT No.: PCT/CN2016/109865

§ 371 Date: Oct. 31, 2017

(30) Foreign Application Priority Data
Jun. 7, 2016 (CN) 201610397589.2

(51) Int. Cl. H04L 9/32; H04W 12/06; H04B 5/00

(52) U.S. Cl. CPC H04L 9/3234; H04L 9/3226; H04W 88/02; H04B 5/0056; H04B 5/0031; H04W 12/06

(57) ABSTRACT

A method and system for NFC-based mobile terminal password storage and recovery is provided. The method includes: binding a mobile terminal and an NFC tag; encrypting password information of the mobile terminal utilizing an identifier of the bound NFC tag; contacting and reading the NFC tag through the mobile terminal if a password input interface is opened and a password is inputted; and decrypting encrypted password information through the identifier of the bound NFC tag and inputting the password obtained after the decrypting into the password input interface if the current NFC tag is a bound NFC tag.

### TECHNICAL FIELD

Embodiments of the present disclosure generally relate to mobile terminals, and in particular relate to a method and system for NFC-based mobile terminal password storage and recovery.

### BACKGROUND

With the rapid development of mobile devices, security issues have attracted more and more attentions. More and more applications need to input a password before being opened or used, so as to improve the security of mobile devices. However, the ordinary password input methods are too complicated, and there will be the risk of password leakage if the process of a user to input a password is seen by others or be recorded.

Therefore, the prior art has to be improved and developed.

### SUMMARY

The present disclosure provides a method and system for NFC-based mobile terminal password storage and recovery. Since NFC is adopted to automatically input a stored password, the recovery of the password can be performed by a user through merely using a mobile device to touch an NFC label, which is not need to input the password, and is easy to use while there is no risk of password leak.

The technical schemes for solving the technical problem of the present disclosure are as follows.

The present disclosure provides an NFC-based mobile terminal password storage and recovery method, including:

A, adding an NFC tag with a unique ID identifier as a password verification device, storing the ID of the NFC tag as a password verification device identifier, and binding a mobile terminal and the NFC tag through the mobile terminal;

B, obtaining password information of the mobile terminal, encrypting the password information utilizing the identifier of the bound NFC tag, and storing the encrypted password information in the mobile terminal; and

C, contacting and reading the NFC tag through the mobile terminal if the mobile terminal opens a password input interface to input a password; and

D, determining whether the current NFC tag is a bound NFC tag, and decrypting the encrypted password information through the identifier of the bound NFC tag and inputting the password obtained after the decrypting into the password input interface if the current NFC tag is a bound NFC tag.

In one embodiment, the step A includes:

A1, contacting and reading the NFC tag, and setting the NFC tag as the password verification device through the mobile terminal; and

A2, storing the ID of the NFC tag as the password verification device identifier, and binding the mobile terminal and the NFC tag.

In one embodiment, the step B includes:

B1, receiving an operation instruction of a user, and entering the password input interface; and

B2, contacting and reading the NFC tag through the mobile terminal after receiving the operation instruction of the user and inputting the password, and entering a password storing process if the current NFC tag is determined to be a bound NFC tag.

In one embodiment, the password storing process of the step B2 includes:

B21, obtaining a password string from a password input box of the password input interface through the mobile terminal;

B22, encrypting the password string utilizing the identifier of the bound NFC tag to obtain a password field, and obtaining an identifier of the current password input interface; and

B23, making the identifier of the password input interface and the password field as a record to be added to a database so as to store in the mobile terminal.

In one embodiment, the step C includes:

C1, opening the password input interface through the mobile terminal; and

C2, contacting and reading the NFC tag through the mobile terminal if the password is not inputted.

In one embodiment, the step D includes:

D1, determining whether the current NFC tag is a bound NFC tag, entering the step D2 if the current NFC tag is a bound NFC tag; and

D2, determining whether the current interface has stored the password, decrypting the password and inputting to the password input interface if the current interface has stored the password.

In one embodiment, the decrypting the password and inputting to the password input interface in the step D2 includes:

D21, obtaining a corresponding password field based on the identifier of the current interface through the mobile terminal;

D22, decrypting the password field based on the identifier of the bound NFC tag to obtain the password string; and

D23, setting the password string obtained by the decrypting to the password input box on the password input interface so as to complete inputting the password.

Furthermore, the present disclosure provides another NFC-based mobile terminal password storage and recovery method, including:

A, adding an NFC tag with a unique ID identifier as a password verification device, storing the ID of the NFC tag as a password verification device identifier, and binding a mobile terminal and the NFC tag through the mobile terminal;

B, storing password information of the mobile terminal after encrypting the password information utilizing the identifier of the bound NFC tag; and

C, contacting and reading the NFC tag through the mobile terminal if the mobile terminal opens a password input interface to input a password, determining whether the current NFC tag is a bound NFC tag, and decrypting the encrypted password information through the identifier of the bound NFC tag and inputting the password obtained after the decrypting into the password input interface if the current NFC tag is a bound NFC tag.

In one embodiment, the step A includes:

A1, contacting and reading the NFC tag, and setting the NFC tag as the password verification device through the mobile terminal; and

A2, storing the ID of the NFC tag as the password verification device identifier, and binding the mobile terminal and the NFC tag.

In one embodiment, the step B includes:

B10, receiving an operation instruction of a user, and entering the password input interface; and

B11, contacting and reading the NFC tag through the mobile terminal after receiving the operation instruction of the user and inputting the password, and entering a password storing process if the current NFC tag is determined to be a bound NFC tag.

In one embodiment, the password storing process of the step B11 includes:

B111, obtaining a password string from a password input box of the password input interface through the mobile terminal;

B112, encrypting the password string utilizing the identifier of the bound NFC tag to obtain a password field, and obtaining an identifier of the current password input interface; and

B113, making the identifier of the password input interface and the password field as a record to be added to a database so as to store in the mobile terminal.

In one embodiment, the step C includes:

C11, opening the password input interface through the mobile terminal;

C12, contacting and reading the NFC tag through the mobile terminal if the password is not inputted, entering the step C13 if the current NFC tag is determined to be a bound NFC tag; and

C13, determining whether the current interface has stored the password, decrypting the password and inputting to the password input interface if the current interface has stored the password.

In one embodiment, the decrypting the password and inputting to the password input interface in the step C13 includes:

C131, obtaining a corresponding password field based on the identifier of the current interface through the mobile terminal;

C132, decrypting the password field based on the identifier of the bound NFC tag to obtain the password string; and

C133, setting the password string obtained by the decrypting to the password input box on the password input interface so as to complete inputting the password.

Still furthermore, the present disclosure provides an NFC-based mobile terminal password storage and recovery system, including:

a binding module configured to control a mobile terminal to add an NFC tag with a unique ID identifier as a password verification device, store the ID of the NFC tag as a password verification device identifier, and bind the mobile terminal and the NFC tag;

an encryption module configured to store password information of the mobile terminal after encrypting the password information utilizing the identifier of the bound NFC tag;

a reading module configured to control the mobile terminal to contact and read the NFC tag if the mobile terminal opens a password input interface to input a password; and

a decryption module configured to determine whether the current NFC tag is a bound NFC tag, and decrypt the encrypted password information through the identifier of the bound NFC tag and input the password obtained after the decrypting into the password input interface if the current NFC tag is a bound NFC tag.

In one embodiment, the binding module includes:

a reading and binding unit configured to control the mobile terminal to contact and read the NFC tag, and set the NFC tag as the password verification device; and

a storage unit configured to store the ID of the NFC tag as the password verification device identifier.

In one embodiment, the encryption module includes:

an interface control unit configured to control the mobile terminal to receive an operation instruction of a user, and enter the password input interface; and

a first determination unit configured to control the mobile terminal to contact and read the NFC tag after receiving the operation instruction of the user and inputting the password, and enter a password storing process if the current NFC tag is determined to be a bound NFC tag.

In one embodiment, the encryption module further includes:

a password string unit configured to control the mobile terminal to obtain a password string from a password input box of the password input interface;

an encryption unit configured to encrypt the password string utilizing the identifier of the bound NFC tag to obtain a password field, and obtain an identifier of the current password input interface; and

an adding unit configured to make the identifier of the password input interface and the password field as a record to be added to a database so as to store in the mobile terminal.

In one embodiment, the reading module includes:

an opening unit configured to open the password input interface; and

a reading unit configured to control the mobile terminal to contact and read the NFC tag if the password is not inputted.

In one embodiment, the decryption module includes:

a second determination unit configured to determine whether the current NFC tag is a bound NFC tag;

a third determination unit configured to determine whether the current interface has stored the password, decrypt the password and input to the password input interface if the current interface has stored the password;

an identifier obtaining unit configured to control the mobile terminal to obtain a corresponding password field based on the identifier of the current interface;

a decryption unit configured to decrypt the password field based on the identifier of the bound NFC tag to obtain the password string; and

a password input unit configured to set the password string obtained by the decrypting to the password input box on the password input interface so as to complete inputting the password.

In one embodiment, the system is a mobile phone, the mobile phone includes:

a display screen configured to display the password input interface; and

an NFC module configured to read the NFC tag and obtain the ID of the NFC tag.

The method and system for NFC-based mobile terminal password storage and recovery provided by the present disclosure adds a new function to a mobile device: NFC password storage and recovery. Whenever a password is stored by the user, the password will not need to be re-input afterward. The recovery of the password can be performed by the user through merely using the mobile device to touch an NFC label, which is not need to input the password, and is easy to use while there is no risk of password leak. As a result, the security of password input is improved, which provides the user with a convenience.

### BRIEF DESCRIPTION OF THE DRAWINGS

FIG. 1 is a flow chart of an NFC-based mobile terminal password storage and recovery method according to a preferred embodiment of the present disclosure.

FIG. 2 is a schematic block diagram of an NFC-based mobile terminal password storage and recovery system according to a preferred embodiment of the present disclosure.

### DETAILED DESCRIPTION

In order to make the objects, technical solutions, and technical effects of the present disclosure more clear, the present disclosure will now be described in more detail with reference to the accompanying embodiments and drawings. It is to be understood that the specific embodiments described herein are merely illustrative of the present disclosure, and are not intended to limit the present disclosure.

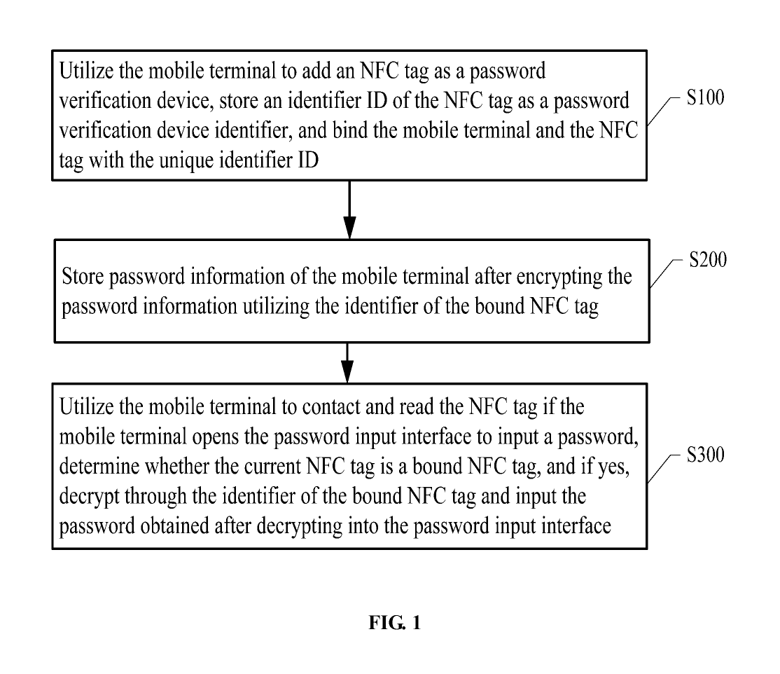

Referring to FIG. 1, a flow chart of an NFC-based mobile terminal password storage and recovery method according to a preferred embodiment of the present disclosure is depicted. The method may include the following blocks.

At block S100: adding an NFC tag as a password verification device by the mobile terminal, and storing an ID of the NFC tag as a password verification device identifier, and binding the mobile terminal and the NFC tag. The NFC tag has one unique ID identifier.

In this embodiment, it is necessary to bind the NFC tag to the mobile terminal (e.g., a mobile phone) of a user in advance, and then input the password through the NFC tag by, for example, using the mobile device to touch and read the NFC tag, set the NFC tag as the password verification device, store the ID of the NFC tag as the password verification device identifier, and then bind the mobile terminal and the NFC tag.

At block S200: storing password information of the mobile terminal in the mobile terminal after encrypting the password information utilizing the identifier of the bound NFC tag.

In this block, it needs to control the mobile terminal to receive the operation instruction of the user to enter a password input interface. After the mobile terminal receives the operation instruction of the user and inputs a password (e.g., 123456), the mobile device contacts and reads the NFC tag, the current NFC tag is determined that whether the current NFC tag is a bound NFC tag or not, and enter a password storing process if it is.

In this embodiment, the password storing process includes: utilizing the mobile terminal to obtain a password string (e.g., 123456) from a password input box of the password input interface; encrypting the password string utilizing the identifier of the bound NFC tag to obtain a password field by, for example, encrypting the password string 123456 and the identifier ID of the NFC tag to obtain the password field and an identifier of the current password input interface (e.g., in Android system, a program name or a Java class path corresponding to the current interface can be used as the interface identifier); making identifier of the password input interface and the password field as a record, and adding the record to a database so as to store in the mobile terminal.

That is, the password storing process is as follows: obtaining the password string from the password input box of the password input interface; encrypting the password string utilizing the identifier of the bound NFC tag to obtain the password field, and obtaining the identifier of the current password input interface (e.g., in Android system, a program name or a Java class path corresponding to the current interface can be used as the interface identifier); and making the identifier of the current password input interface and the password field as the record to be added to the database so as to store in the mobile terminal.

At block S300: utilizing the mobile terminal to contact and read the NFC tag if the mobile terminal opens the password input interface to input a password, determine whether the current NFC tag is a bound NFC tag, and decrypt the encrypted password information through the identifier of the bound NFC tag and input the password obtained after the decrypting into the password input interface if the current NFC tag is a bound NFC tag.

In this embodiment, when it is needed to input the password, the mobile terminal opens the password input interface; when the password is not inputted, the mobile device contacts the NFC tag to read the NFC tag, and determines whether the current NFC is a bound NFC tag; if not, it ends, otherwise the current interface is determined whether has stored the password, and the corresponding password is decrypted and inputted into the password input interface.

In one embodiment, the decrypting the corresponding password and inputting into the password input interface includes:

obtaining the corresponding password field by the mobile terminal based on the identifier of the current interface; decrypting the password field based on the identifier of the bound NFC tag to obtain the password string; and setting the password string obtained by the decrypting to the password input box on the password input interface so as to complete inputting the password.

That is, in this embodiment, if the password is not inputted in the password input interface, and the user makes the mobile terminal to contact the NFC tag and read the NFC tag, it is determined whether the current NFC is the password verification device which has been stored and the current interface has stored the password. If it is, a password recovery process is triggered.

The password recovery process is as follows: obtaining the password field based on the identifier of the current interface; decrypting the password field based on the identifier of the password verification device to obtain the password string; and setting the password string to the password input box on the password input interface so as to complete inputting the password.

As can be seen from the above, a method adopting NFC to automatically recover the stored password is provided. After the password is stored, the user is not need to input the password repeatedly in the subsequent use. The recovery of the password can be performed by the user through merely using the mobile device to touch an NFC label, which is not needed to input the password, and is easy to use while there is no risk of password leak.

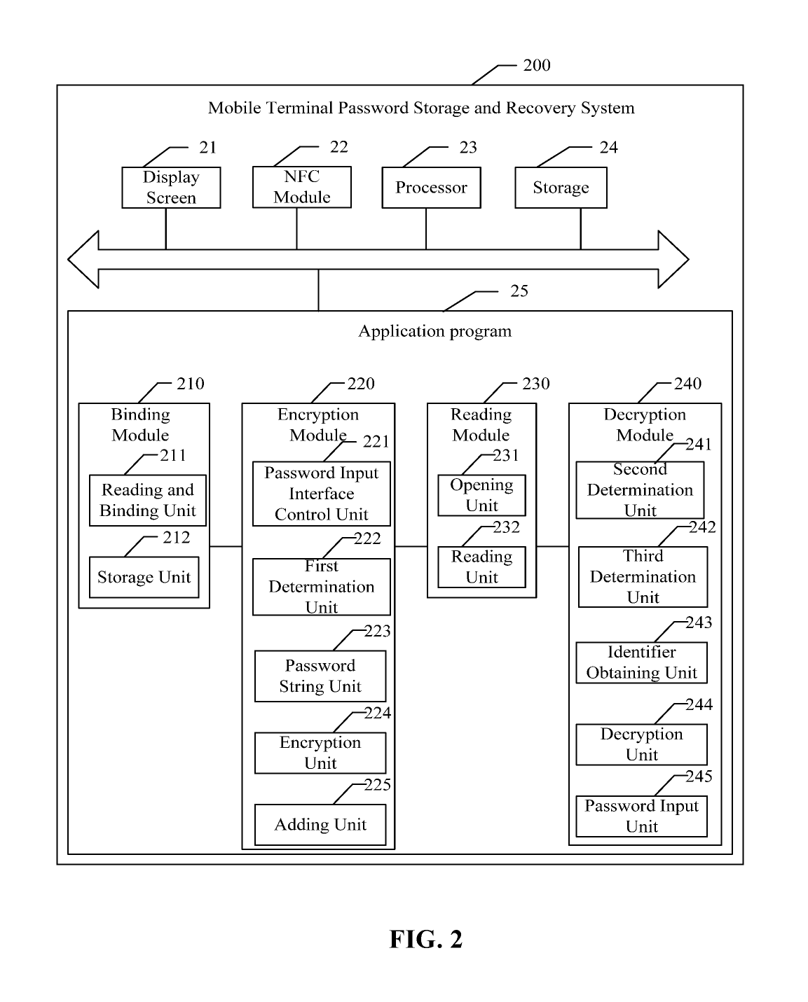

Based on the above-mentioned method embodiment, the present disclosure further provides an embodiment of password storage and recovery system for a mobile terminal. Referring to FIG. 2, a schematic block diagram of an NFC-based mobile terminal password storage and recovery system according to a preferred embodiment of the present disclosure is depicted. The system can be but is not limited to a mobile phone. The system 200 includes: a display screen 21, an NFC module 22, one or more processors 23, a storage 24, and an application program 25.

The display screen 21 is configured to display the password input interface.

The NFC module 22 is configured to read the NFC tag and obtain the identifier ID of the NFC tag.

The one or more programs 25 are stored in the storage 24 and configured to be executed by the processor 23. The one or more applications 25 include instructions to execute a binding module 210, an encryption module 220, a reading module 230, and a decryption module 240.

The binding module 210 is configured to control the mobile terminal to add an NFC tag as the password verification device, store the ID of the NFC tag as the password verification device identifier, and bind the mobile terminal and the NFC tag. The NFC tag has one unique ID identifier.

The encryption module 220 is configured to store the password information of the mobile terminal after encrypting the password information utilizing the identifier of the bound NFC tag.

The reading module 230 is configured to control the mobile terminal to contact and read the NFC tag if the mobile terminal opens the password input interface to input the password.

The decryption module 240 is configured to determine whether the current NFC tag is a bound NFC tag, and decrypt the encrypted password information through the identifier of the bound NFC tag and input the password obtained after the decrypting into the password input interface if the current NFC tag is a bound NFC tag.

Particularly, the binding module 210 includes:

a reading and binding unit 211 configured to control the mobile terminal to contact and read the NFC tag, and set the NFC tag to be the password verification device; and

a storage unit 212 configured to store the ID of the NFC tag as the password verification device identifier.

Particularly, the encryption module 220 includes:

a password input interface control unit 221 configured to control the mobile terminal to receive an operation instruction of a user, and enter the password input interface;

a first determination unit 222 configured to control the mobile terminal to contact and read the NFC tag after receiving the operation instruction of the user and inputting the password, determine whether the current NFC tag is a bound NFC tag, and if it is, enter the password storing process;

a password string unit 223 configured to control the mobile terminal to obtain the password string from the password input box of the password input interface;

an encryption unit 224 configured to encrypt the password string utilizing the identifier of the bound NFC tag to obtain the password field, and obtain the identifier of the current password input interface; and

an adding unit 225 configured to make the identifier of the password input interface and the password field as the record to be added to the database so as to store in the mobile terminal.

Particularly, the reading module 230 includes:

an opening unit 231 configured to open the password input interface; and

a reading unit 232 configured to control the mobile terminal to contact and read the NFC tag if the password is not inputted.

Particularly, the decryption module 240 includes:

a second determination unit 241 configured to determine whether the current NFC tag is a bound NFC tag;

a third determination unit 242 configured to determine whether the current interface has stored the password, and decrypt the corresponding password and input to the password input interface if the current interface has stored the password;

an identifier obtaining unit 243 configured to control the mobile terminal to obtain the corresponding password field based on the identifier of the current interface;

a decryption unit 244 configured to decrypt the password field based on the identifier of the bound NFC tag to obtain the password string; and

a password input unit 245 configured to set the password string obtained by the decrypting to the password input box on the password input interface so as to complete inputting the password.

In view of the above, the method and system for NFC-based mobile terminal password storage and recovery provided by the present disclosure adds a new function to a mobile device: NFC password storage and recovery. Whenever a password is stored by the user, the password will not need to be re-input afterward. The recovery of the password can be performed by the user through merely using the mobile device to touch an NFC label, which is not need to input the password, and is easy to use while there is no risk of password leak. As a result, the security of password input is improved, which provides the user with a convenience.

Of course, those skilled in the art will understand that implementing all or part of the processes in the method of the embodiments described above may be accomplished by a computer program that commands the associated hardware (e.g., a processor or a controller, etc.). The program can be stored in a computer-readable storage medium such as a storage, a magnetic disk, an optical disk, etc. The program may include, at the time of execution, the steps of the method embodiments as described above.

It is to be understood that the application of the present disclosure is not limited to the above-mentioned examples, and for those skilled in the art, improvements or modifications can be performed in accordance with the above description, and all the improvements and modifications should be within the scope of the protection of the present disclosure.

1. An NFC-based (Near-Field-Communication-based) mobile terminal password storage and recovery method, comprising:
step A, adding an NFC tag with a unique identifier as a password verification device, storing the identifier of the NFC tag as a password verification device identifier, and binding a mobile terminal and the NFC tag through the mobile terminal;
step B, obtaining password information of the mobile terminal, encrypting the password information utilizing the identifier of the bound NFC tag, and storing the encrypted password information in the mobile terminal;
step C, contacting and reading the NFC tag through the mobile terminal if the mobile terminal opens a password input interface to input a password; and
step D, determining whether the current NFC tag is a bound NFC tag, and decrypting the encrypted password information through the identifier of the bound NFC tag and inputting the password obtained after the decrypting into the password input interface if the current NFC tag is a bound NFC tag.

2. The method of claim 1, wherein the step A comprises:
step A1, contacting and reading the NFC tag, and setting the NFC tag as the password verification device through the mobile terminal; and
step A2, storing the identifier of the NFC tag as the password verification device identifier, and binding the mobile terminal and the NFC tag; and wherein the identifier of the NFC is ID identifier.

3. The method claim 1, wherein the step B comprises:
step B1, receiving an operation instruction of a user, and entering the password input interface; and
step B2, contacting and reading the NFC tag through the mobile terminal after receiving the operation instruction of the user and inputting the password, and entering a password storing process if the current NFC tag is determined to be a bound NFC tag.

4. The method claim 3, wherein the password storing process of the step B2 comprises:
step B21, obtaining a password string from a password input box of the password input interface through the mobile terminal;
step B22, encrypting the password string utilizing the identifier of the bound NFC tag to obtain a password field, and obtaining an identifier of the current password input interface; and
step B23, making the identifier of the password input interface and the password field as a record to be added to a database so as to store in the mobile terminal.

5. The method claim 1, wherein the step C comprises:
step C1, opening the password input interface through the mobile terminal; and
step C2, contacting and reading the NFC tag through the mobile terminal if the password is not inputted.

6. The method claim 5, wherein the step D comprises:
step D1, determining whether the current NFC tag is the bound NFC tag, entering the step D2 if the current NFC tag is the bound NFC tag; and
step D2, determining whether the current interface has stored the password, decrypting the password and inputting to the password input interface if the current interface has stored the password.

7. The method claim 6, wherein the decrypting the password and inputting to the password input interface in the step D2 comprises:
step D21, obtaining a corresponding password field based on the identifier of the current interface through the mobile terminal;
step D22, decrypting the password field based on the identifier of the bound NFC tag to obtain the password string; and
step D23, setting the password string obtained by the decrypting to the password input box on the password input interface so as to complete inputting the password.

8. An NFC-based (Near-Field-Communication-based) mobile terminal password storage and recovery method, comprising:
step A, adding an NFC tag with a unique identifier as a password verification device, storing the identifier of the NFC tag as a password verification device identifier, and binding a mobile terminal and the NFC tag through the mobile terminal;
step B, storing password information of the mobile terminal after encrypting the password information utilizing the identifier of the bound NFC tag; and
step C, contacting and reading the NFC tag through the mobile terminal if the mobile terminal opens a password input interface to input a password, determining whether the current NFC tag is a bound NFC tag, and decrypting the encrypted password information through the identifier of the bound NFC tag and inputting the password obtained after the decrypting into the password input interface if the current NFC tag is a bound NFC tag.

9. The method of claim 8, wherein the step A comprises:
step A1, contacting and reading the NFC tag, and setting the NFC tag as the password verification device through the mobile terminal; and
step A2, storing the identifier of the NFC tag as the password verification device identifier, and binding the mobile terminal and the NFC tag; and wherein the identifier of the NFC is ID identifier.

10. The method claim 8, wherein the step B comprises:
step B10, receiving an operation instruction of a user, and entering the password input interface; and
step B11, contacting and reading the NFC tag through the mobile terminal after receiving the operation instruction of the user and inputting the password, and entering a password storing process if the current NFC tag is determined to be a bound NFC tag.

11. The method claim 10, wherein the password storing process of the step B11 comprises:
step B111, obtaining a password string from a password input box of the password input interface through the mobile terminal;
step B112, encrypting the password string utilizing the identifier of the bound NFC tag to obtain a password field, and obtaining an identifier of the current password input interface; and
step B113, making the identifier of the password input interface and the password field as a record to be added to a database so as to store in the mobile terminal.

12. The method claim 8, wherein the step C comprises:
step C11, opening the password input interface through the mobile terminal;
step C12, contacting and reading the NFC tag through the mobile terminal if the password is not inputted, entering the step C13 if the current NFC tag is determined to be a bound NFC tag; and
step C13, determining whether the current interface has stored the password, decrypting the password and inputting to the password input interface if the current interface has stored the password.

13. The method claim 12, wherein the decrypting the password and inputting to the password input interface in the step C13 comprises:
step C131, obtaining a corresponding password field based on the identifier of the current interface through the mobile terminal;
step C132, decrypting the password field based on the identifier of the bound NFC tag to obtain the password string; and
step C133, setting the password string obtained by the decrypting to the password input box on the password input interface so as to complete inputting the password.

14. An NFC-based (Near-Field-Communication-based) mobile terminal password storage and recovery system, comprising a processor and a memory, wherein, the processor is configured to:
control a mobile terminal to add an NFC tag with a unique identifier as a password verification device, store the identifier of the NFC tag as a password verification device identifier, and bind the mobile terminal and the NFC tag;
store password information of the mobile terminal after encrypting the password information utilizing the identifier of the bound NFC tag;
control the mobile terminal to contact and read the NFC tag if the mobile terminal opens a password input interface to input a password; and
determine whether the current NFC tag is a bound NFC tag, and decrypt the encrypted password information the encrypted password information through the identifier of the bound NFC tag and input the password obtained after the decrypting into the password input interface if the current NFC tag is a bound NFC tag.

15. The system of claim 14, wherein the processor is further configured to:
control the mobile terminal to contact and read the NFC tag, and set the NFC tag as the password verification device; and
store the identifier of the NFC tag as the password verification device identifier; and wherein the identifier of the NFC is ID identifier.

16. The system of claim 14, wherein the processor is further configured to:
control the mobile terminal to receive an operation instruction of a user, and enter the password input interface; and
control the mobile terminal to contact and read the NFC tag after receiving the operation instruction of the user and inputting the password, and enter a password storing process if the current NFC tag is determined to be a bound NFC tag.

17. The system of claim 14, wherein the processor is further configured to:
control the mobile terminal to obtain a password string from a password input box of the password input interface;
encrypt the password string utilizing the identifier of the bound NFC tag to obtain a password field, and obtain an identifier of the current password input interface; and
make the identifier of the password input interface and the password field as a record to be added to a database so as to store in the mobile terminal.

18. The system of claim 14, wherein the processor is further configured to:
open the password input interface; and
control the mobile terminal to contact and read the NFC tag if the password is not inputted.

19. The system of claim 14, wherein the processor is further configured to:
determine whether the current NFC tag is a bound NFC tag;
determine whether the current interface has stored the password, decrypt the password and input to the password input interface if the current interface has stored the password;
control the mobile terminal to obtain a corresponding password field basing on the identifier of the current interface;
decrypt the password field based on the identifier of the bound NFC tag to obtain the password string; and
set the password string obtained by the decrypting to the password input box on the password input interface so as to complete inputting the password.

20. The system of claim 14, wherein the system is a mobile phone, the mobile phone comprises:
a display screen configured to display the password input interface; and
an NFC module configured to read the NFC tag and obtain the identifier of the NFC tag.
